(19) United States
(12) Patent Application Publication
(10) Pub. No.: US 2005/0008828 A1
(43) Pub. Date: Jan. 13, 2005

(54) Patterned polymer microgel and method of forming same

(75) Inventors: Matthew R. Libera, New Providence, NJ (US); Svetlana A. Sukhishvili, Maplewood, NJ (US); Peter Krsko, New Brunswick, NJ (US)

Correspondence Address: RALPH W. SELITTO, JR.;C/O MCCARTER & ENGLISH, LLP, GATEWAY CENTER FOUR, 100 MULBERRY STREET, NEWARK, NJ, 07102, US

(73) Assignee: Trustees of Stevens Institute of Technology

(21) Appl. No.: 10/626,472

(22) Filed: Jul. 24, 2003

Related U.S. Application Data
(60) Provisional application No. 60/398,392, filed on Jul. 25, 2002.
(60) Provisional application No. 60/441,658, filed on Jan. 22, 2003.

(51) Int. Cl. B05D 3/00; G21H 1/00

(52) U.S. Cl. 428/195.1; 427/551

(57) ABSTRACT

Surface-patterned microgels are formed by treating polymer films like electron-beam photoresists, but without destroying or removing the patterned microgels from their substrate. Focused electron beams are used to create patterned microgels on surfaces where the enhanced spatial resolution can be exploited to create gels with characteristic length scales relevant to cellular and sub-cellular processes. Varying the beam intensity allows control of the concentration of proteins that adhere to the resulting microgel. The process can be used to precisely locate the adhesive junction between cells and a substrate and to confine cell growth within defined areas.

### CROSS-REFERENCE TO RELATED APPLICATIONS

This application claims the benefit of U.S. Provisional Patent Application No. 60/398,392, filed Jul. 25, 2002, and U.S. Provisional Patent Application No. 60/441,658, filed Jan. 22, 2003.

### FIELD OF THE INVENTION

Polymeric gels, having micron or submicron dimensions, for adsorption of proteins and adhesion of cells.

### BACKGROUND OF THE INVENTION

Surface patterning at appropriate length scales is of significance to many emerging application areas, particularly those involving proteins and cells. In addition to well-established technologies based on photolithography, surface patterning has been achieved by techniques such as soft lithography, microfluidic patterning, 3-D printing, and dip-pen nanolithography, among other traditional and hybrid approaches. Patterning using electron beams has been practiced for several decades and has the advantage of enabling the generation of surface-patterned structures with arbitrary shapes and feature sizes as small as a few tens of nanometers. In the context of modifying surfaces for biorelevant applications, these properties are important because the control of protein and cell behavior on synthetic surfaces requires control of surface structure and chemistry at lengths ranging across both the nano-scale and micro-scale. Because of their usefulness in biological systems, due to their unique interactions with water, hydrogels have been and continue to be extensively studied in the context of biomedical devices and drug-delivery technologies and, more recently, for microfluidic applications.

Hydrogels are cross-linked soluble polymers which swell because of their affinity for water but do not dissolve in water due to structural and/or chemical crosslinks. Among the various synthetic water-soluble polymers developed and studied as hydrogels, poly(ethylene glycol) [PEG] has received considerable attention. PEG is an amphiphilic polymer, soluble not only in water but also in a range of organic solvents, with FDA approval for in-vivo application. Its antifouling properties in biomaterials applications are well known, and it has been used extensively to resist protein and cell adhesion. Cross-linking has been achieved in PEG and its higher molecular weight relative, poly(ethylene oxide) [PEO], both by modification of the polymer chemistry and by exposure to radiation such as ultraviolet (UV) light, X-rays, or electrons. Exposure to high-energy electron radiation has been used to promote cross-linking reactions in dilute aqueous PEG solutions using MeV energy electrons from an accelerator. This approach has been used to study the effects of incident dose, polymer concentration in solution, polymer molecular weight, polymer architecture, and biophysical response, among other possible variables.

Relatively little attention has been applied to the use of focused electron beams of low or intermediate energy and the effects that such beams have on dry films of gel-relevant polymer on solid substrates. In contrast, a great deal of practical knowledge is known about irradiating thin films of photosensitive polymers by highly controlled electron beams for lithographic applications associated principally with semiconductor device technology. Such polymer resist technology is quite advanced. Negative resists, e.g. poly(styrene), are made of polymers which cross-link under irradiation and become less soluble. Positive resists (e.g. poly(methyl methacrylate)) suffer chain scission under irradiation and become more soluble. Substantial effort over several decades has centered on the development of multicomponent resist formulations having optimimum sensitivity and resolution. Because it is a serial process, e-beam lithography has been used largely for custom patterning such as mask making. Since it offers inherently high resolution, there has been increasing interest in parallel processes based on projection electron-beam lithography.

In the present invention, and in contrast to previous work on PEG and PEO hydrogels, electron beams are used to create arbitrary and irregular patterns of fine-scale gels on surfaces. The method is used to form microgels (i.e., hydrogels and gels having affinity for solvents other than water, which have dimensions in the nano-scale to micro-scale ranges). Because of a dramatic dependence of protein adsorption and cell adhesion on the swelling properties of the microgels, the placement of such proteins and cells on polymer substrates can be controlled lithographically.

### SUMMARY OF THE INVENTION

In one aspect, the present invention presents a patterned polymer microgel, supported by a substrate, comprising a polymer film having a pattern on its surface with detailed features in the submicron range. The pattern is distinguished from the non-patterned portion of the polymer film by one or more distinguishing properties, such as the degree of cross-linking of the polymer film, the extent to which the polymer swells when exposed to a solvent, the affinity of the polymer or substrate for adsorption of a protein or some other molecule, or the affinity of the polymer or substrate for the adhesion of a cell. In a preferred embodiment, the pattern has an arbitrary and irregular arrangement. In another preferred embodiment, the distribution of one or more distinguishing property is arbitrarily arranged within the pattern. In other embodiments, the patterned polymer microgel is provided with protein molecules adsorbed to the patterned surface or cells adhered to the patterned surface.

In another aspect, the present invention provides a method of making a patterned polymer microgel by exposing a dry polymer film to a source of electron radiation under high vacuum so as to form a pattern of exposed polymer film. In a preferred embodiment, the polymer film is exposed to a low-energy focused electron beam that is rastered across a series of positions over the polymer film according to a pattern. This process enables the formation of finely detailed arbitrary patterns having features in the submicron range. In another preferred embodiment, the intensity of incident electron radiation is modulated at each position that is exposed to the rastered electron beam so as to produce an arbitrary distribution of incident radiation exposure within the resulting pattern. In yet another preferred embodiment, a patterned radiation mask is positioned between the dry polymer film and the source of electron radiation, and the film and mask are irradiated with a wide-area electron beam.

In yet other aspects, the invention provides methods for controlling the location and degree of protein adsorption on a polymer film and for controlling the adhesion of cells to a polymer film. In these aspects, a patterned polymer microgel is formed and subsequently exposed to protein molecules or cultured with cells to produce a polymer film having proteins and/or cells within the patterned areas of the film.

### BRIEF DESCRIPTION OF THE DRAWINGS

FIG. 1 is a scanning electron micrographic image of a patterned polymer microgel according to the present invention.

FIG. 2 is a binarized and skeletonized image derived from the image of FIG. 1 illustrating a typical test pattern for dose-dependent irradiation.

FIG. 3 is an atomic force micrographic image of a pad of the patterned polymer microgel of FIG. 1 in a dry state.

FIG. 4 is an atomic force micrographic image of the pad of FIG. 3 while immersed in water.

FIG. 5 is a plot of the height profiles from the images of FIGS. 3 and 4.

FIG. 6 is a plot comparing the height profiles of an array of pads of images in FIGS. 7 and 8.

FIG. 7 is an atomic force micrographic image of the patterned polymer microgel of FIG. 1 in a dry state.

FIG. 8 is an atomic force micrographic image of the patterned polymer microgel of FIG. 1 while immersed in water.

FIG. 9 is a plot of the normalized heights of the pads in a patterned poly(ethylene glycol) [PEG 6800] microgel in wet and dry states as a function of the incident electron radiation dosage received by each pad.

FIG. 10 is a plot of normalized heights of the pads in a patterned poly(ethylene oxide) [PEO 200k] microgel in wet and dry states as a function of the incident electron radiation dosage received by each pad.

FIG. 11 is a plot comparing the vertical swell ratios of the PEG 6800 and PEO 200k microgels of FIGS. 9 and 10 as a function of incident electron dose.

FIG. 12 is a fluorescence optical micrographic image of the patterned polymer microgel of FIG. 1 with fibronectin adsorbed thereto.

FIG. 13 is a plot of the fluorescent intensity of the visible pads in the image of FIG. 12 as a function of the pads' vertical swell ratios.

FIG. 14 is a light optical micrographic image of a patterned polymer microgel formed from a pattern according to a method of the present invention.

FIG. 15 is a representation of the pattern used in forming the patterned polymer microgel of FIG. 14.

FIG. 16 is a fluorescent optical micrographic image mapping the spatial distribution of fibronectin adsorbed onto the patterned polymer microgel of FIG. 14.

FIG. 17 is a profile of fluorescent intensity across a portion of the image of FIG. 16.

FIG. 18 is a reflected light micrographic image of a PEG 6800 pad exposed to a low electron radiation dose, then subjected to a cell culture procedure.

FIG. 19 is a reflected light micrographic image of a PEG 6800 pad exposed to an intermediate electron radiation dose, then subjected to a cell culture procedure.

FIG. 20 is a reflected light micrographic image of a PEG 6800 pad exposed to a high electron radiation dose, then subjected to a cell culture procedure.

FIG. 21 is a scanning electron micrographic image of two fibroblast cells adhered to and confined within a region of electron beam irradiated PEG 6800.

FIG. 22 is an enlarged view of the portion of the electron irradiated PEG 6800 of FIG. 21 within which the two fibroblast cells are confined.

FIG. 23 is a fluorescence optical micrographic image of patterned region of a polymeric film in a continuous film of unexposed polymer, mapping the spatial distribution of fibronectin adsorbed to the polymeric film.

FIG. 24 is a depiction of the four-row array of exposure areas forming the patterned region of FIG. 23.

FIG. 25 is a micrographic image of fibroblasts adhering to a polymeric film, having an irradiated portion and a non-irradiated portion, that is normally resistant to cell adhesion.

FIG. 26 is a micrographic image of fibroblasts adhering to a non-irradiated polymeric film that normally accepts cell adhesion.

FIG. 27 is a micrographic image of a patterned polymer microgel showing fibroblasts constrained to adopt specific sizes, shapes and locations by electron-beam patterning.

FIG. 28 is an enlarged view of a first fibroblast of FIG. 27.

FIG. 29 is an enlarged view of a second fibroblast of FIG. 28.

FIG. 30 is an enlarged view of a third fibroblast of FIG. 29.

FIG. 31 is a schematic image having a geometrically complex pattern adjacent to a micrographic image of a patterned polymer microgel formed according to the same complex pattern with submicron-scale details.

### DETAILED DESCRIPTION OF THE INVENTION

Microgels which are patterned on some underlying substrate can be fabricated by radiation cross-linking of polymer films using several different methods. In a preferred embodiment, the pattern and the cross-linking are generated simultaneously using a focused source of radiation, such as a focused electron beam, which can be directed to irradiate a laterally homogeneous polymer film to form the laterally-modulated, two-dimensional pattern of interest. This embodiment may employ many of the operational principles associated with electron-beam lithography as commonly practiced, for example, in the manufacture of semiconductor devices. An example of such techniques is rastering, wherein the focused radiation source is moved across the surface of the polymer film according to a digitized pattern.

The foregoing embodiment may be practiced in a number of variants, each of which is within the scope of the invention, depending on the desired characteristics or uses of the patterned microgels. In their most general form, such variants include the steps of selecting a suitable polymer/solvent system, forming a laterally homogenous polymer film on a substrate from a solution of the selected polymer in the selected solvent, exposing selected portions of the polymer film to a radiation source under high vacuum to form a pattern of cross-linked polymer, and removing the unexposed, uncross-linked polymer by washing the film with a solvent. Examples of such variants are presented herein.

In a first variant, the following steps are performed to create a microgel that swells when exposed to water, such swelling being controlled by the degree of cross-linking of the polymer. A polymer film is created having a thickness that is, for example, between 5 nm and 1000 nm, from a water-soluble polymer such as poly(ethylene glycol) [PEG]. The polymer film may be formed, for example, by casting from a solution of polymer dissolved in a suitable solvent, for example, tetrahydrofuran [THF], dichloromethane [DCM] or water, onto a solid surface such as a silicon wafer. Thereafter the film is exposed to an external source of radiation (e.g., a focused electron beam) to produce the desired patterns. The dose of radiation applied to the film is controlled to achieve the desired degree of polymer cross-linking. For example, a 100 nm thick film of PEG may require a dose of 10⁻⁵-10³ C/m² from a 10 keV electron source to produce sufficient cross-linking to form a microgel. The polymer in the areas which have not been irradiated is then dissolved, for example, by washing the film in an appropriate solvent such as water, THF or DCM. The characteristic size of the patterned microgel remaining on the surface after this washing step is determined by the size of the area of the film that was exposed to radiation in the previous step. The microgel created in the immediately previous step is then caused to swell by exposing it to a solvent such as THF, DCM or, more preferably, water. The extent of swelling depends on the affinity of the polymer gel for the solvent.

In a second variant, a film formed of a polymer, such as poly(desamino tyrosyl-tyrosine ethyl ester carbonate) [poly(DTE carbonate)], which is preferentially soluble in organic solvents, is patterned by a source of radiation to create a microgel that swells when exposed to an organic solvent. The same sequence of steps is followed as in the first variant, except that the polymer solution comprises the polymer dissolved in an organic solvent such as THF or DCF, and unexposed polymer film is washed away in such an organic solvent. As in the first variant, the microgel swells when it is exposed to an organic solvent such as THF, or DCM, and to a lesser extent when exposed to water.

In a third variant, a film formed of a polymer such as poly(methacrylic acid) [PMAA], in which the densities of charged and hydrogen-bonding moieties vary in concentration depending on the environmental pH, is patterned by a source of radiation to create a microgel that swells when exposed to water, such swelling being controlled both by the degree of cross-linking and by the pH of an aqueous solution. The same sequence of steps is followed as in the first variant, except that the polymer solution comprises the polymer dissolved in a polar organic solvent such as methanol, and unexposed polymer film is washed away in such a polar organic solvent or in an aqueous solution having a pH at which the polymer has an optimum solubility. Such a microgel will swell when exposed to an aqueous solution, such as a buffer, with the extent of swelling depending on the pH of the microgel's environment. In the example cited (i.e., cross-linked PMAA), the extent of swelling increases as the pH of the water surrounding the microgel increases.

A fourth variant provides a further method to create a microgel that swells when exposed to water, with such swelling being controlled by the degree of cross-linking attained in the microgel and by the pH of the microgel's aqueous environment. A multilayer film is created from two distinct polymers A and B, where, for example, polymer A is PEG and polymer B is PMM. Such a film is formed by allowing the polymers A and B to adsorb separately, in sequence, onto an inert solid surface such as a silicon wafer to create a multilayer film having separate layers of polymer A and polymer B which adhere to each other by hydrogen bonding or electrostatic attraction. The film is then patterned as described for the first variant. The unexposed polymer is then dissolved, for example, by washing the film in an appropriate solvent such as methanol or water at a selected pH. Such a microgel will swell when exposed to an aqueous solution, such as a buffer, with the extent of swelling depending on the pH of the microgel's environment. In the example cited (i.e., layers of PEG and PMM), the extent of swelling increases as the pH of the water surrounding the microgel increases.

A fifth variant provides a method of using patterned microgels to place controlled amounts of protein on the surface of a substrate. Under this variant, a patterned microgel is first produced using the methods of the first, second, third or fourth variants, or by some other suitable method. The patterned microgel is then exposed to a buffered protein solution under conditions which promote binding of the protein to the microgel (e.g., exposure to human plasma fibronectin (Fn) in phosphate-buffered saline with calcium (PBS-C) buffer at about 37° C. for about 2 hours). Thereafter the microgel is rinsed in PBS-C or an equivalent buffer. The extent of protein adsorption on the microgel can be visualized using, for example, fluorescence optical microscopy or electron microscopy. After rinsing in PBS-C or an equivalent buffer, the microgel patterns may be exposed to a primary antibody, such as rabbit anti-human primary antibody, for 30 minutes. After rinsing again in PBS-C or equivalent buffer, the microgel patterns are further exposed to a secondary antibody labeled with a fluorescent tag (e.g., flourescein-conjugated goat antirabbit IgG secondary antibody for 30 minutes) for fluorescence optical microscopy or with gold nanoparticles for electron microscopy.

In a sixth variant of the invention, a patterned microgel, formed as described in variant three or variant four, is loaded with a drug or other type of molecule, which is then released in a controlled manner by altering the environmental conditions of the microgel (e.g., by altering the environmental pH or ionic strength). In an example of this variant, the patterned microgel is loaded by immersion in an aqueous solution containing a drug molecule, complex, or other molecule having a net charge or hydrogen-bonding moiety that is complementary to the charge or hydrogen-bonding moiety of the microgel. For example, a PMM microgel at pH>4 will have a net negative charge and, therefore, the drug, complex, or other molecule should have a net positive charge in order to load efficiently into the microgel. The microgel is then rinsed in a buffer solution of the same pH. The microgel can then be held at this pH for an extended period, for example, days, weeks, or months depending on the specific system. Release of the loaded molecule is triggered by exposing the microgel to an aqueous solution containing lower concentrations, down to none, of the loaded molecule and having a pH that is different than the loaded pH. The change in pH decreases the affinity of the microgel for the loaded molecule, which is then released into the environment of the microgel. Other aspects of this variant are disclosed more fully in the co-pending, co-owned U.S. patent application METHOD FOR CONTROLLED RELEASE OF MOLECULES FROM LAYERED POLYMER FILMS by S. Sukhishvili and E. Kharlampieva, filed in the United States Patent and Trademark Office on Jul. 22, 2003, the disclosure of which is incorporated herein by reference.

In a seventh variant of the invention, a patterned microgel, formed according to one of the first, second, third or fourth variants, is used to selectively place and confine living cells (e.g., fibroblasts) by controlling the cells' adhesion to the patterned microgels. After the microgel is patterned, a cell-binding material (e.g., fibronectin) is allowed to adsorb to the patterned microgel, and cells are cultured on the patterned surfaces following standard methods of cell culture. The cultured cells adhere, and may be confined to, the areas where the polymer film has been more heavily irradiated and do not adhere to the areas of the polymer film that have been irradiated lightly or, depending on the polymer, not irradiated at all.

In an eighth variant of the invention, which may be referred to as “projection beam patterning’, a source of projected radiation, such as wide-area-exposure electron-beam irradiation, is projected through to a laterally homogenous polymer film, with or without an intervening mask, where pattern formation and cross-linking occur simultaneously. Such a method may be preferred to the use of focused electron beam in applications where a grid comprising a large number (e.g., thousands) of microgel pads is to be formed, such as in a microgel arrangement that would be analogous to a biochip. This methodology is similar to that used in contract printing practiced in a variety of light-based lithographies. A thin film of PEO200k is formed on a silicon substrate, by the methods described above, and one or more copper grids commercially available for standard use in the field of transmission electron microscopy were mounted onto the PEO200k film surface. These grids serve as masks and either partially or entirely block incident electrons from reaching the polymer film below. Masks with custom patterns could be created using established fabrication methods. This process of wide-area electron-beam contact printing may be used to create arrays consisting of hundreds of square cross-linked PEO200k pads where the edges of each square pad are approximately 0.025 mm. For those skilled in the art of projection electron-beam lithography, it will be obvious that the approach can be extended to combine the advantages of the wide-area irradiation of contact printing (large regions of exposure) and focused irradiation (detauiled patterning and submicron feature sizes).

Further variations of the foregoing embodiments, particularly with respect to selection of materials (e.g., polymers, solvents, proteins or cell types), methods of forming, patterning and cross-linking the polymer films, environmental conditions for implementing the variants discussed above (e.g., pH and temperature ranges) and the like, which would become apparent to one skilled in the art upon reading this disclosure, are to be considered as part of this invention. The following examples and the data curves and tables resulting therefrom are explanatory and illustrative of selected variants of the invention but should not be considered as limiting the scope of the invention.

### EXPERIMENTAL EXAMPLES

Materials:

Poly(ethylene glycol) of molecular weight (M_{w}) 6800 daltons [PEG 6800] and poly(ethylene oxide) of M_{w}=200,000 daltons [PEO 200k], both purchased from Scientific Polymer Products (Ontario, Canada), were used as received. HPLC-grade tetrahydrofuran [THF] (catalog no. 27,038-5, Aldrich Chemical Company, Milwaukee Wis.), HPLC/UV-grade acetone (catalog no. 32900, Pharmco Products, Inc., Brookfield Conn.), anhydrous 200-proof ethyl alchohol (catalog no. 45983-6, Aldrich Chemical Company) and stabilized C.P.-grade dichloromethane [DCM] (CAS no. 75-09-2, Acros Organics USA, Morris Plains, N.J.) were all used as received. Three-inch single-crystal wafers of boron-doped [100]-oriented silicon (catalogue no. C13B5C05E01A0525-11), approximately 0.5 mm thick and polished on one side, were purchased from Virginia Semiconductor (Fredericksburg, Va.). Type I water with a resistance exceeding 15 Mohms*cm was produced using a Millipore Direct Q system for combined reverse osmosis and deionization treatments. Human plasma fibronectin (Fn) cell binding fragments (catalog no. 08-103, lot no. 21609) were obtained from Upstate Biotechnology (Lake Placid, N.Y.). Rabbit anti-human Fn primary antibody (catalog no. AB1945 lot no. 21071284) was purchased from Chemicon International (Temecula, Calif.). Flourescein (FITC) conjugated AffiniPure goat anti-rabbit IgG H+L secondary antibody (catalog. no. 111-095-144, lot no. 50227) was obtained from Jackson ImmunoResearch (West Grove, Pa.). Phosphate buffer saline with calcium (PBS-C) was used at pH 7.4.

Silicon Substrate Preparation:

Silicon substrates were prepared by cleaving [100] single-crystal wafers (0.5 mm thick) into sections approximately 1 cm×1 cm in area. In a first substrate cleaning process, each substrate was sonicated in acetone for 5 minutes and then in ethanol for 5 minutes. The surface was dried using a nitrogen gas stream. In a second cleaning process, substrates were exposed to UV irradiation from a mercury grid lamp of maximum power of 450 W for 5 minutes. These substrates were then further exposed to 5% hydrofluoric acid in water for 5 minutes, rinsed in distilled water, exposed again to UV radiation for 5 minutes, and finally exposed to a RF oxygen plasma for 7 minutes. These two substrate cleaning methods led to comparable results when subsequently casting PEG and PEO thin films on them.

Solvent Casting of Polymer Thin Films:

Thin polymer films having thicknesses of about 100 nm were cast by dropping 50 μl of a 2 wt % solution of either PEG 6800 or PEO 200k in THF onto the polished side of the cleaned silicon wafer spinning at approximately 4000 rpm. The silicon substrate was fixed to the spinner either by a vacuum chuck or by double-sided adhesive. After 20 minutes of spinning, the wafer was annealed at 320 K under a vacuum of approximately 50 mTorr for 2 hours. Films of thicknesses ranging from 50 nm to 600 nm were also made by this method, using polymer solutions with concentrations ranging from 0.3 wt % to 6 wt %, respectively. In general, the PEO 200k films tended to be thicker than the PEG 6800 films under nominally identical casting procedures.

Electron-Beam Patterning:

Polymer films on silicon substrates were exposed to electron irradiation in a LEO 982 DSM field-emission scanning electron microscope (FEG-SEM) (LEO Electron Microscopy, Thornwood, N.Y.). The vacuum in the specimen chamber during electron irradiation was maintained at approximately 10⁻⁶ Torr. The electron accelerating energy used was 10 keV, and a typical beam current was in the range from 20-100 pA. The electron beam position and dwell time at each pixel position were controlled using an Emispec Vision data acquisition and control computer system (Emispec Systems, Tempe, Ariz.). Exposure patterns ranging from individual points, to lines generated by a linear sequence of points, to square pads generated by a two-dimensional array of exposure points, could all be generated using the scripting capabilities of the Emispec Vision software. Square exposure areas were generated by digitally rastering an electron beam, approximately 10 nm in diameter, across the polymer surface in a square array of exposure points. An average dose, D, for such an exposure was determined by normalizing the total number of electrons to the total area exposed to electron irradiation: D=(i×t×N)/A where i is the beam current, t is the dwell time per pixel, and N is the number of pixels in the array.

Removal of insufficiently cross-linked polymer after irradiation corresponds to the development of a resist in conventional photolithography. In the experiments of the present example, irradiation led to cross-linking of the polymer which caused the cross-linked polymer to become insoluble in water, DCM or THF. Unirradiated or insufficiently cross-linked polymer was soluble in each of the three solvents. Irradiated specimens were developed by washing in solvent immediately after being removed from the vacuum environment. The specimens were immersed and gently agitated for 5 minutes in 200 ml of THF and then rinsed by immersion in 200 ml of Type 1 water. The developed specimens were then dried under flowing nitrogen gas. Micron-sized particulates were observed on the surface of some specimens after development, but did not appear to affect the experimental results in a substantive manner.

Morphological Analysis of Micropatterned PEG

The specimens were studied at four stages during the experimental tests: (1) after electron-beam exposure; (2) after development of the exposed films; (3) after assessment of the film heights by atomic force microscopy [AFM]; and (4) after protein adsorption studies, using the same LEO 982 FEG SEM that was used to write patterns on the polymer films. Particular care was taken when studying films prior to the development step to minimize the electron dose given to any particular area. Quantitative measurements of film height were made in air as well as in water (pH 5.6) using a Nanoscope IIIa scanning probe microscope (Digital Instruments—Veeco Metrology Group). Imaging was performed using Veeco Nanoprobe tips (model NP-20). Flourescence optical microscopy was done using a Zeiss microscope with 20× and 40× objectives. Quantitative analysis of digital image data was performed using the Digital Micrograph software system from Gatan, Inc. (Pleasanton, Calif.).

### Example 1

### Characterization of Patterned Polymer Microgels

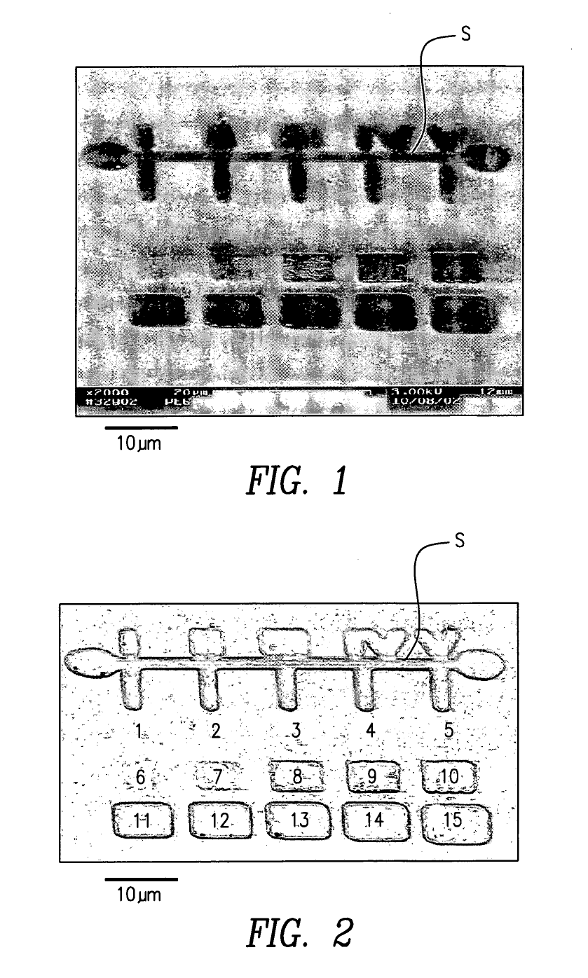

Patterned polymer microgels were characterized for their developmental characteristics (e.g., stability) and swelling properties. FIG. 1 shows the results of irradiation and development of a patterned microgel from a PEG 6800 film according to the first variant of the preferred embodiment of the present invention. As outlined in the skeletonized image of the PEG 6800 film (i.e., in FIG. 2), fifteen square areas, numbered 1-15, were irradiated. These areas were created as an array of three rows of five square irradiation areas each. Each square area was generated by a two-dimensional raster of 60 pixels by 60 pixels over an area of 5.4 microns by 5.4 microns. The interpixel spacing was 90 nm. A fiducial pattern S with Roman numerals I-V was written with the electron beam, at a dose of 70 C/m², to facilitate identification of the various exposure areas. The average doses for the fifteen exposed areas are summarized in Table 1.

TABLE 1
Average Dose of Electron Irradiation for the Exposure Pattern

| Pattern No. | Dwell Time (s) | Dose (C/m²⁾ |
|---|---|---|
| 1 | 0.001 | 0.003 |
| 2 | 0.004 | 0.012 |
| 3 | 0.007 | 0.021 |
| 4 | 0.01 | 0.031 |
| 5 | 0.04 | 0.122 |
| 6 | 0.07 | 0.214 |
| 7 | 0.1 | 0.306 |
| 8 | 0.4 | 1.223 |
| 9 | 0.7 | 2.140 |
| 10 | 1 | 3.057 |
| 11 | 4 | 12.228 |
| 12 | 7 | 21.399 |
| 13 | 10 | 30.570 |
| 14 | 40 | 122.279 |
| 15 | 70 | 213.988 |

At the lowest doses (i.e., at positions 1-5), no polymer remained on the silicon surface after washing with THF, presumably due to insufficient cross-linking and attachment to the silicon face. At high doses (i.e., at positions 6-15), square pads remained at the silicon surface after washing with THF. One can conclude that, within this higher dose range, electron exposure leads to a net cross-linking effect and attachment to the surface. Developed polymer films of PEO 200k show similar behaviors to the films of PEG 6800, i.e., under the conditions of these experiments, PEG and PEO behave like negative photoresists.

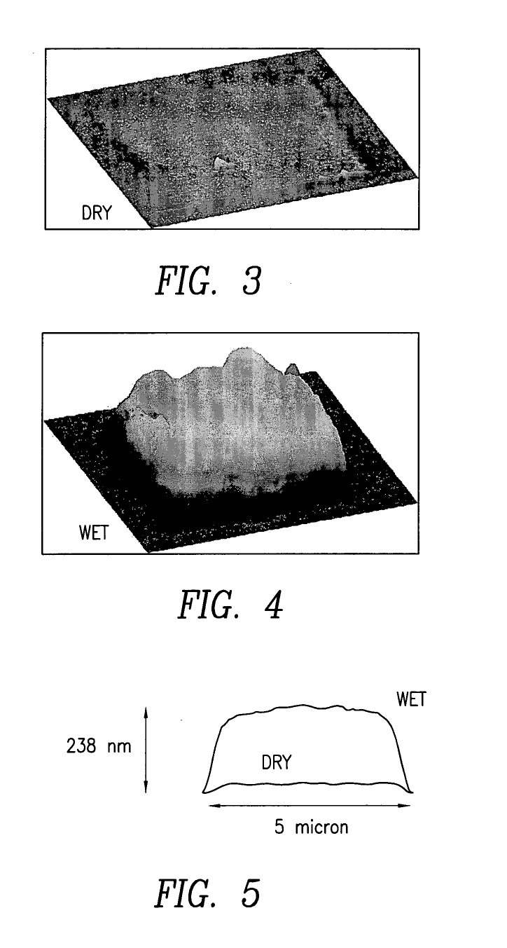

FIGS. 3-5 illustrate the basic swelling phenomenon observed in the pads of cross-linked PEG 6800 or PEO 200k. FIG. 3 shows an AFM image of a pad of PEG 6800 (specifically, pad 7 of FIG. 1) in its dry state after development. The image of FIG. 4 was collected in-situ and shows the same pad in its hydrated state. As shown on the cross-sectional schematic drawing in FIG. 5, the pad height increased from an average of 31.5 nm in the dry state to an average height of 238.2 nm in the wet state. Also notable, from a comparison among FIGS. 3-5, is that the swelling is highly anisotropic, with little change in the lateral pad dimensions. It is believed likely that this effect is due to the constraints imposed by the binding of the pad to the silicon surface.

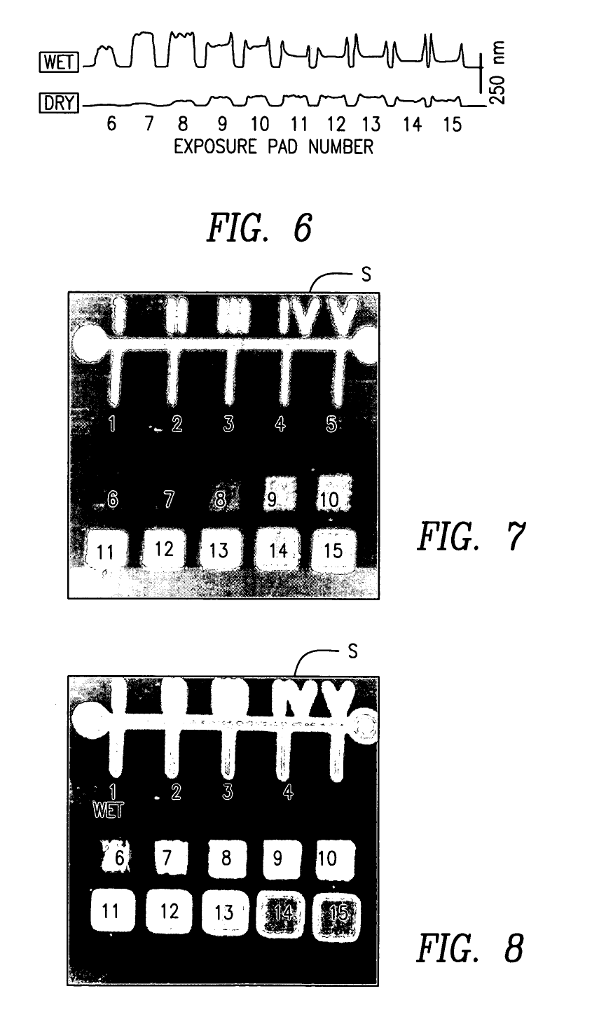

FIG. 6 shows height profile characteristics of ten PEG 6800 pads created at different exposure doses (i.e., pads 6-15). These profiles were generated from AFM image data on dry pads (e.g., on the developed film shown in FIG. 7) and in-situ AFM measurements taken on the same pads in water (e.g., on the developed film shown in FIG. 8). It is notable that the edges of the height profiles characterizing the higher dose pads (e.g., pads 11-15) are significantly higher than those characterizing the central portion of those same pads. Without being bound by a particular theory, we attribute this to the effect of electrons backscattered from the substrate, which would result in the areas adjacent to those irradiated by the incident beam also receiving a dose of radiation, but at a lower intensity than the area treated by the incident beam itself. The edge swelling is less apparent in the range of lower doses (e.g., 1-10 C/m² at pads 6-10) in part because it is masked in this range by the significant swelling of the central portion of the pad. For larger doses, the swelling of the pad centers is relatively small, so the edge swelling is more visible.

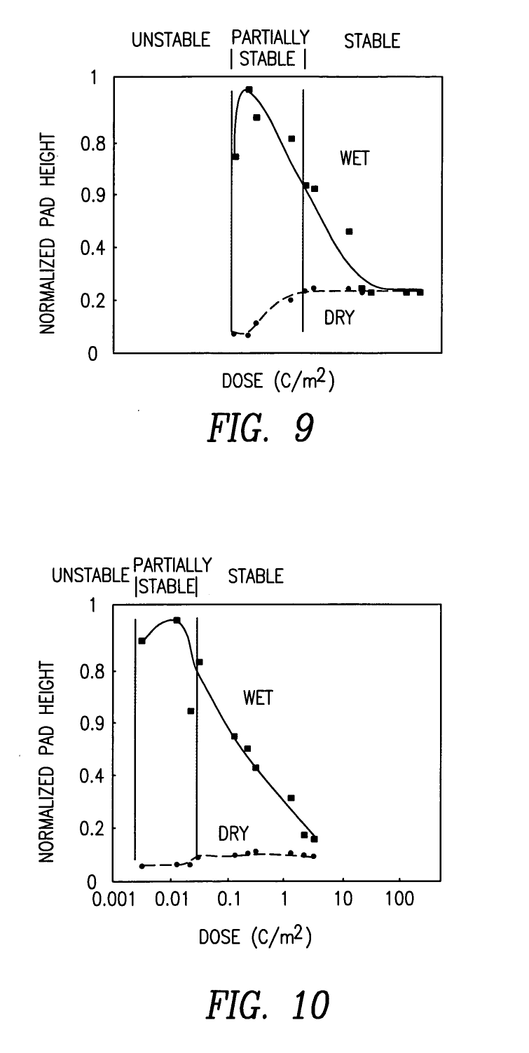

A more significant observation is that the swelling of the central area of each pad depends strongly on the radiation dose. The pad-swelling behavior for films of PEG 6800 (FIG. 9) and POE 200k (FIG. 10) is presented as a function of incident electron dose. Each point in FIGS. 9 and 10 represents an average determined from either five (PEG 6800) or three (PEO 200k) different experiments. Based on the dry thickness measurements, we can identify three different regions of pad stability, as marked on FIGS. 9 and 10: unstable pads; partially stable pads; and stable pads. There is a lower limiting dose below which no microgel pads remained on the silicon surface. Pads formed by irradiation below the lower limiting dose are unstable and, as discussed below, their instability may be attributed to insufficient cross-linking and adhesion to the substrate. In the region of partially stable pads, the dry pad height varies weakly with incident dose. It is in the region of partial stability that the greatest differences in pad heights between the wet and dry states are observed. Finally, at higher radiation doses, the dry pad height is constant. The pads fabricated at these higher doses are stable. An important observation from FIGS. 9 and 10 is that, except for the lower dose portions of the partially stable regions, the hydrated pad height decreases with increasing dose. At the highest doses, the PEG 6800 dry and wet pad heights are essentially identical.

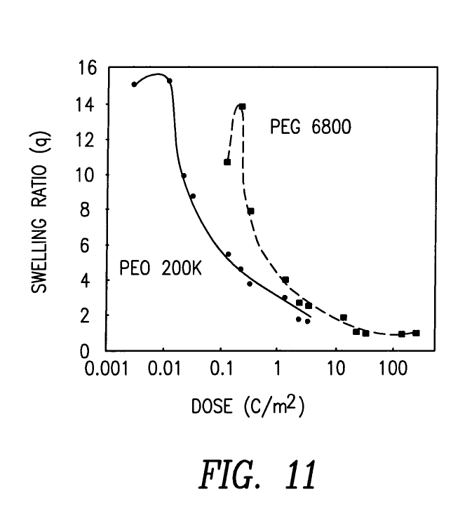

The same swelling trends are manifested by the swelling ratios plotted in FIG. 11. The swelling ratio, q, was determined as the ratio of the vertical pad heights:
q=h_{wet}/h_{dry}

where h_{wet} and h_{dry} are the wet and dry pad heights, respectively. FIG. 11 shows that PEG 6800 and PEO 200k pads achieve maximum swelling ratios of about 14 and 16, respectively. Beyond these maxima, the microgels are stable and the swelling ratios fall monotonically with increasing dose towards a limit of unity. The data on which FIG. 11 is based are included in Tables 2 and 3, below.

TABLE 2
Pad Heights - PEO 200 K Experimental data for FIG. 11*

| Pad No. | 1 | 2 | 3 | 4 | 5 | 6 | 7 | 8 | 9 | 10 |
|---|---|---|---|---|---|---|---|---|---|---|
| Dose | 0.003 | 0.012 | 0.021 | 0.031 | 0.122 | 0.214 | 0.306 | 1.23 | 2.14 | 3.06 |
| Dry (1) | 75 | 81 | 82 | 117 | 125 | 133 | 142 | 130 | 126 | 123 |
| Wet (1) | 1128 | 1240 | 814 | 1082 | 637 | 591 | 510 | 423 | 230 | 188 |
| Dry (2) | 79 | 82 | 85 | 121 | 132 | 143 | 149 | 136 | 127 | 123 |
| Wet (2) | 1151 | 1229 | 821 | 1043 | 752 | 645 | 612 | 373 | 211 | 214 |
| Dry (3) | 74 | 84 | 79 | 116 | 121 | 135 | 137 | 130 | 121 | 116 |
| Wet (3) | 1172 | 1280 | 821 | 1004 | 702 | 670 | 511 | 390 | 221 | 205 |

*Dose unit is C/m² height unit is nm.

TABLE 3
Pad Heights - PEG 6800 Experimental data for FIG. 11*

| Pad No. | 5 | 6 | 7 | 8 | 9 | 10 | 11 | 12 | 13 | 14 | 15 |
|---|---|---|---|---|---|---|---|---|---|---|---|
| Dose | 0.122 | 0.214 | 0.306 | 1.22 | 2.14 | 3.06 | 12.2 | 21.4 | 30.6 | 122 | 214 |
| Dry (1) | 13 | 14 | 20 | 38 | 46 | 47 | 47 | 44 | 45 | 47 | 44 |
| Wet (1) | 143 | 192 | 173 | 153 | 118 | 118 | 89 | 46 | 45 | 46 | 44 |
| Dry (2) | 15 | 14 | 25 | 42 | 45 | 47 | 48 | 46 | 46 | 45 | 44 |
| Wet (2) | 149 | 202 | 186 | 178 | 126 | 121 | 88 | 51 | 46 | 45 | 44 |
| Dry (3) | 15 | 14 | 20 | 36 | 42 | 46 | 46 | 43 | 43 | 43 | 43 |
| Wet (3) | 147 | 187 | 169 | 147 | 117 | 115 | 76 | 44 | 43 | 43 | 42 |
| Dry (4) | 11 | 12 | 19 | 39 | 46 | 46 | 47 | 45 | 44 | 44 | 43 |
| Wet (4) | 140 | 185 | 157 | 149 | 121 | 120 | 91 | 46 | 44 | 44 | 44 |
| Dry (5) | 13 | 16 | 26 | 41 | 48 | 51 | 47 | 47 | 45 | 46 | 45 |
| Wet (5) | 140 | 199 | 180 | 158 | 131 | 126 | 95 | 53 | 46 | 47 | 45 |

*Dose unit is C/m² and height unit is nm.

### Example 2

### Adsorption of Fibronectin onto PEG Microgels

Patterned surfaces generated by electron irradiation and subsequent development were exposed to human plasma fibronectin (Fn) at 37° C. for 2 hours in PBS-C buffer. After rinsing in PBS-C buffer for three iterations of 5 minutes each, the specimens were immersed in rabbit anti-human primary antibody for 30 minutes at room temperature. These were then rinsed in PBS-C buffer for three iterations of 5 minutes each and exposed to flourescein-conjugated goat antirabbit IgG secondary antibody at room temperature for 30 minutes. The specimens were then washed in PBS-C buffer for three iterations of 5 minutes each, rinsed in running Type I water for 30 seconds, and finally dried under flowing nitrogen gas.

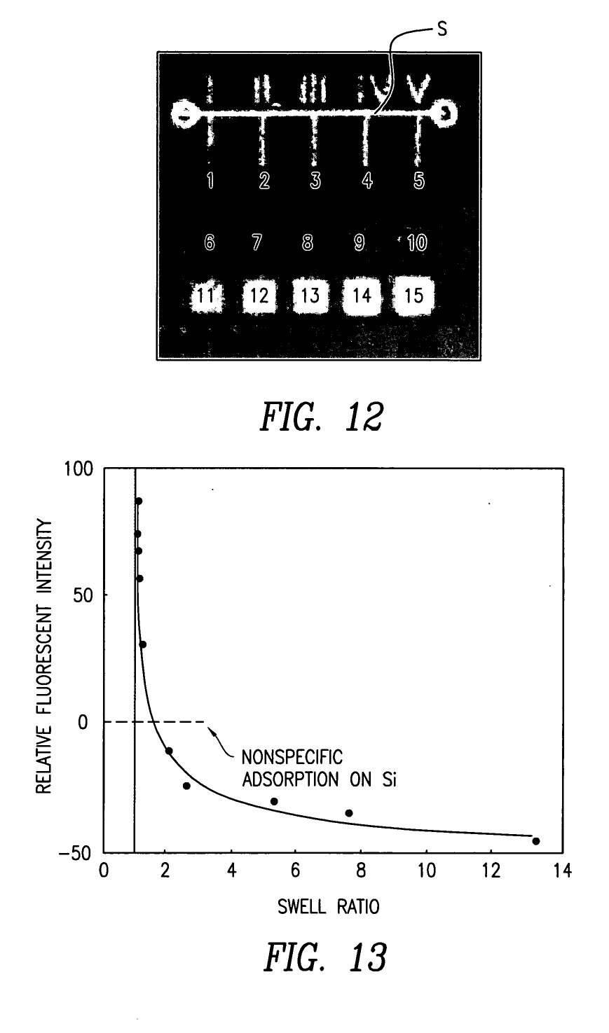

Typical experimental results are shown in FIGS. 12 and 13. FIG. 12 shows a 256-bit greyscale fluorescence optical micrograph of the pad array of FIG. 1. The fluorescence is due to the localization of FITC-labeled secondary antibody with adsorbed fragments of human fibronectin. Brighter contrast corresponds to higher concentrations of adsorbed fibronectin. The background surrounding the electron-beam written pad array has a non-zero intensity. This corresponds to the nonspecific adsorption of fibronectin onto the silicon substrate after the unirradiated PEG is washed away. It is apparent from examination of FIG. 12 that the degree of fibronectin adsorption is a function of the electron dose used to create a particular pad. Fibronectin adsorption is hindered relative to background when pads are created with low incident doses (i.e., pads 6-10). Fibronectin adsorption is enhanced, however, for pads created with high incident doses (i.e., pads 11-15).

The finding that the degree of fibronectin binding can be controlled simply by varying the incident electron dose is surprising and unexpected. Poly(ethylene glycol)s [PEGs], in general, are known to resist protein adsorption and such materials are often employed to prevent adhesion of proteins to surfaces. Therefore, it is surprising to find that electron-beam irradiation can be used to promote adhesion, and, moreover, to control the degree of adhesion, of fibronectin by controlling the dose of electron irradiation to which the PEG and PEO thin films are exposed.

To create FIG. 13, the fluorescent intensity over the central portion of each pad was averaged and the averaged values were plotted as a function of swell ratio. The background fluorescence in FIG. 12 was modeled and subtracted from the measured fluorescence values. Consequently, FIG. 13 plots relative fluorescent intensities as a function of swell ratio where an intensity value of zero corresponds to nonspecific adsorption of fibronectin on silicon. Examination of FIGS. 12 and 13 reveals that microgels which are only lightly cross-linked, and thus swell substantially, hinder the adsorption of fibronectin. In fact, swell ratios greater than about 2 are sufficient to increase the microgels' resistance to protein adsorption relative to background. In contrast, the adsorption of fibronectin is enhanced relative to the background when the swell ratio falls below about 1.5. The amount of fibronectin adsorption increases dramatically as the swell ratios approach unity (i.e., at the highest electron doses studied in this Example).

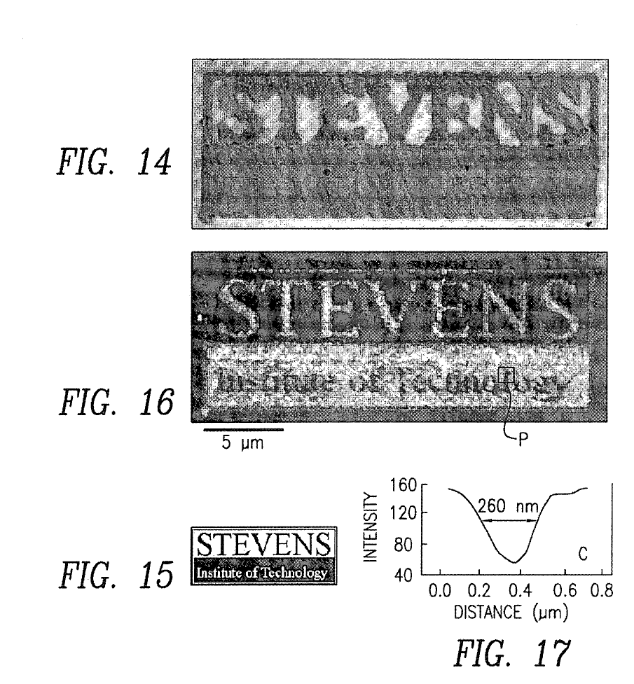

FIGS. 14-17 demonstrate that arbitrary patterns of Fn-adsorbing PEG can be generated using the electron-beam lithographic approach. The developed polymer film of FIG. 14 was created using a binarized arrangement of the name of the Stevens Institute of Technology (Hoboken, N.J.) with an interpixel spacing of 100 nm and dose conditions like those of pad 11 of FIG. 1 (see also Table 1). An example of the arrangement used is shown in FIG. 15. FIG. 14 is a reflected-light optical micrograph where dark contrast corresponds to regions where cross-linked PEG 6800 remains after development. FIG. 16 is a fluorescence optical micrograph that shows the spatial distribution of adsorbed fibronectin on the patterned PEG. Bright contrast corresponds to a higher concentration of adsorbed fibronectin and is localized most strongly in areas where the polymer received the highest exposure from the direct electron beam.

Examination of FIGS. 14 and 16 reveals that the method of the present Example can generate continuous PEG pads where the affinity for fibronectin adsorption can be modulated at a sub-micron scale. It can be observed that the words “Institute of Technology” are visible in the fluorescence image of FIG. 16 but are not apparent in the reflected-light image of FIG. 14. The latter image (FIG. 14) shows that a polymer pad is present in the area of the words, and the former image (FIG. 16) shows that fibronectin adsorbs at some locations within the polymer pad but not at others. A linear profile of fluorescent intensity (FIG. 17) was measured horizontally across the letter “I” in the word “Technology”, where indicated by the marked area P (see FIG. 16), and was averaged over 25 pixels vertically along the letter “I”. The full-width at half-maximum (FWHM) of decreased intensity associated with this feature is 260 nm. Considering the properties of the polymer film and silicon substrate and the nature of the electron-beam irradiation process, it is almost certain that the length scale of the features is controlled by backscattered electrons from the incident electron beam. It is expected that there would be no fundamental limit to achieving feature sizes in the polymer film on the order of a few tens of nanometers as have been achieved in polymeric resists for semiconductor devices.

### Example 3

### Control of Cell Adhesion on PEG Films

Thin films of PEG 6800 were solvent cast onto cleaned silicon substrates and exposed to patterned electron-beam irradiation following the procedures outlined above. For one specimen, three pads, each approximately 200 microns by 300 microns in size, were created using incident radiation doses which sampled conditions in the ranges where fibronectin does not adsorb at all to those where fibronectin adsorbs extensively.

Fibroblasts were cultured on the electron-beam-patterned surfaces following standard methods of cell culture. After irradiation and development, the PEG 6800 surfaces were prepared by allowing them to adsorb fibronectin (Fn) at an ambient concentration of 0.1 mg/ml in PBS for 90 minutes at 37° C. The samples were removed from the Fn solution, washed twice with PBS for 5 minutes at 37° C. and once with deionized water for 5 minutes at 37° C. NIH 3T3 fibroblasts were grown in Minimum Essential Medium Eagle supplemented with L-glutamine (1%), Fetal Bovine Serum (10%), and Penicillin-Streptomycin (1%) in a incubator with 5% CO₂ at 37° C. The fibroblasts were removed from tissue culture flasks by incubating in 0.25% trypsin-EDTA for 2 minutes and centrifuged at 1000 rpm for 3 minutes. The cell culture medium was aspirated and replaced with serum-free Fibroblast Basal Medium. This washing step was repeated three times. Cells were then reseeded at a concentration of 10⁶/ml and incubated for 30 minutes at 37° C. and 5% CO₂. The solution was removed, and the reseeding step was repeated. After another 30 minutes of incubation, more serum-free Fibroblast Basal Medium with 1% Penicillin-Streptomycin was added and the samples were placed in the incubator at 37° C. with 5% CO₂ for 12 hours. Then the cell culture medium was removed, and the samples were washed twice with PBS for 5 minutes at 37° C., fixed with 4% paraformaldehyde for 20 minutes at room temperature, washed with PBS for 10 minutes again, and finally washed once with deionized water for 5 minutes. At that point they were observed by optical microscopy. In addition, some of the cell culture experiments were performed using serum-containing medium rather than serum-free medium.

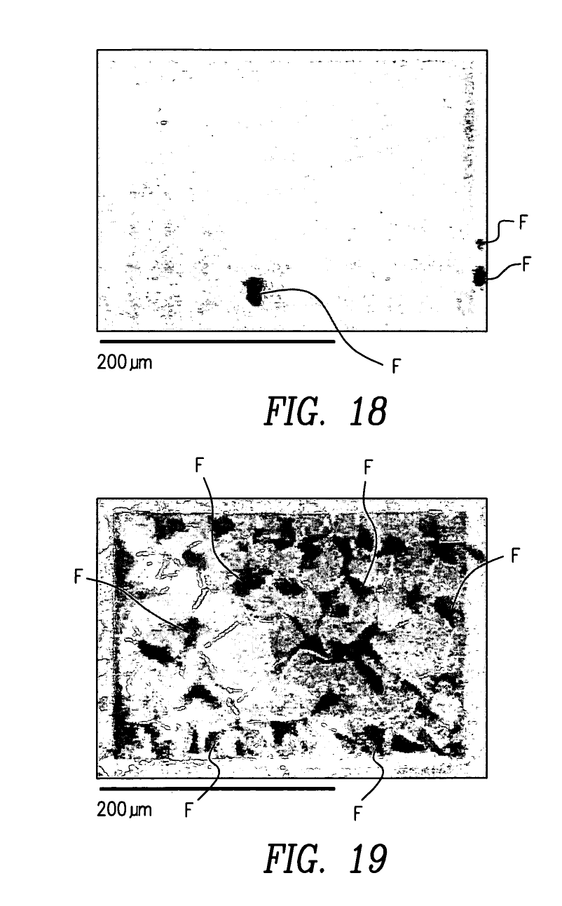

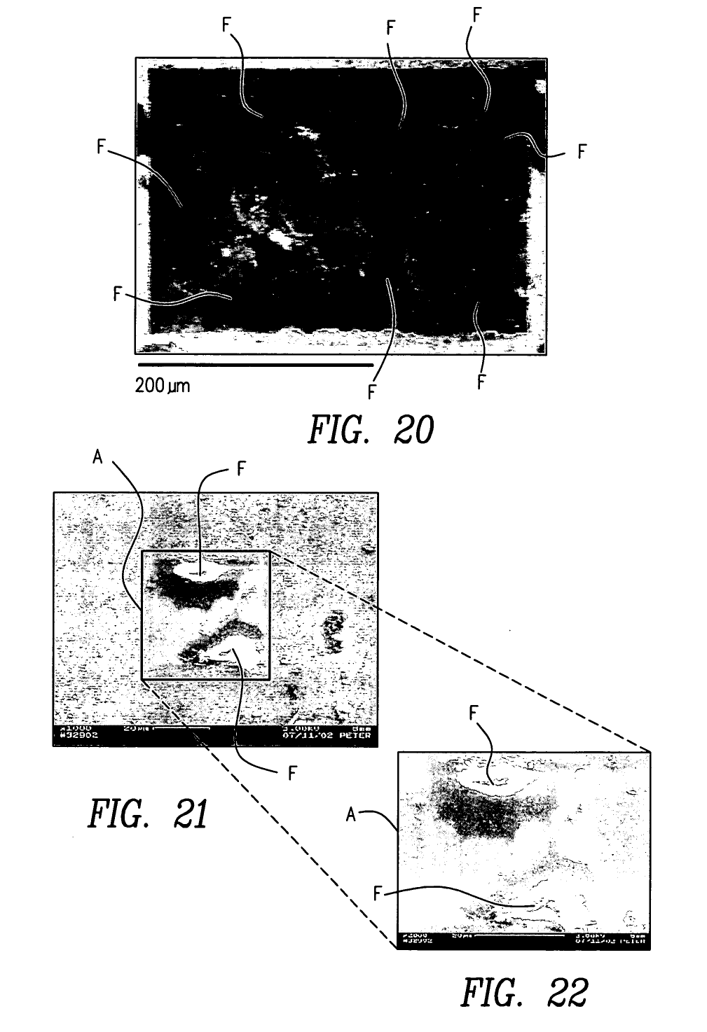

As illustrated by FIG. 18, fibroblasts F do not adhere to the PEG surface exposed to lower electron doses, specifically, 0.5 C/m², whereas increasing numbers of fibroblasts F adhere under conditions of higher electron doses, specifically, 5 C/m² (FIG. 19) and 50 C/m² (FIG. 20). At the highest doses studied, a confluent layer of fibroblasts F was created (see FIG. 20). By laterally modulating the electron dose and exploiting the patterning capabilities of the electron-beam irradiation method disclosed herein, polymer films can be patterned to create specific locations where individual cells will adhere to the film surface. In the polymer film shown in FIGS. 21 and 22, a 30 micron by 30 micron square area A was irradiated with a high dose at which fibronectin adsorbs heavily, while the area surrounding the square was irradiated with a low dose at which fibronectin does not adsorb to the film. FIG. 21 shows that two fibroblast cells adhered to the square area that had been exposed to the higher radiation dose and were confined to grow within the boundary of that area. FIG. 22 provides a view of the two fibroblast cells at a larger scale. As shown in Examples 1 and 2, the size, shape, and position of microgel pads can all be controlled by the lateral modulation of dose and submicron spatial resolution of the focused electron beam irradiation. Therefore it should also be possible to control the size, shape and position of the cell-adhesive regions. Extending this concept to the finest length scales, one can expect that the adhesive property of the square pad can itself be modulated to, for example, control the specific locations and sizes of focal adhesions between the cell and the substrate below it, with spatial resolution at the micron and submicron scale.

### Example 4

### Control of Protein Adsorption and Cell Adhesion on Poly(DTE-co-PEG Carbonate) and Poly(DTE Carbonate)

Poly(DTE carbonate) is a poly(pseudo amino acid) disclosed by U.S. Pat. No. 6,120,491. Poly(DTE-co-PEG carbonate) is a random block copolymer disclosed by U.S. Pat. No. 6,319,492. Many relevant protein-adsorption and cell-adhesion properties of these materials are described in the open literature.

In the experimental work supporting this example, both poly(DTE carbonate) and poly(DTE-co-8 wt %-PEG1000 carbonate) were patterned following methods similar to those disclosed herein for the electron-beam patterning of PEG and PEO. Thin films of each of these polymers were cast onto cleaned silicon substrates from high vapor pressure organic solvents (either THF or DCM). These films were exposed to focused 10 keV electron irradiation under high vacuum in a FEG SEM. As with PEG and PEO, this form of electron irradiation cross-links the polymer in a dose-dependent manner. After irradiation, the unexposed polymer was removed from the substrate surface by rinsing in an appropriate solvent. Since these and similar polymers are insoluble in water, it would also have been practical to skip the development step, leaving a continuous film with specific regions patterned in that film by laterally modulated electron irradiation.

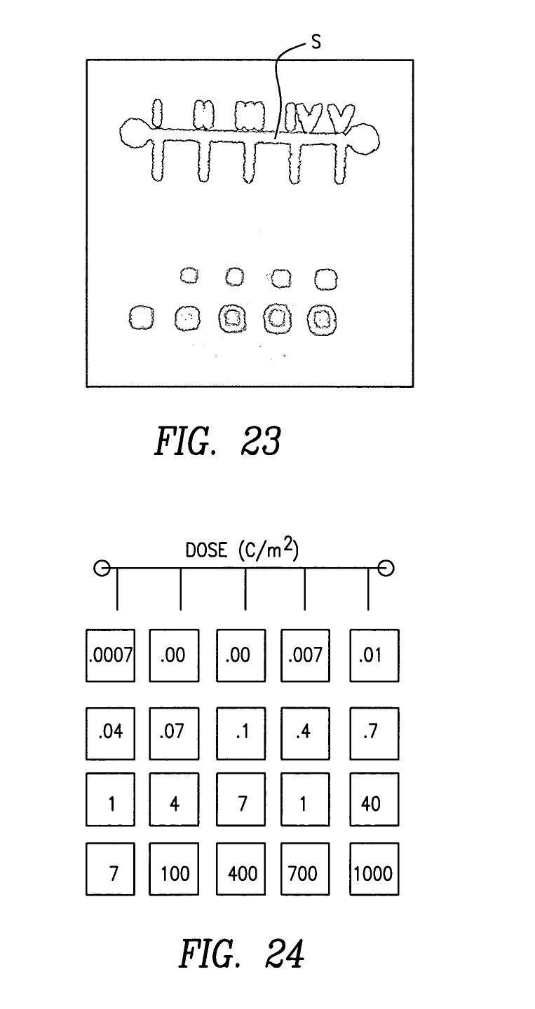

As was the case with the PEG films of Example 2, control of the adsorption of fibronectin and other proteins onto a patterned surface can be achieved by controlling the incident dose of radiation to which the patterned surface is exposed. FIG. 23 is a typical fluorescent image of a developed poly(DTE carbonate) film that has been treated following the procedure of protein exposure, fluorescent labeling, and imaging outlined for PEG in Example 2. The electron-beam irradiation dose for each exposure region is shown in FIG. 24. As can be observed by the fluorescent intensities of the pads in FIG. 23, the amount of adsorbed fibronectin increases with the amount of incident radiation to which the respective areas on the polymer film were exposed.

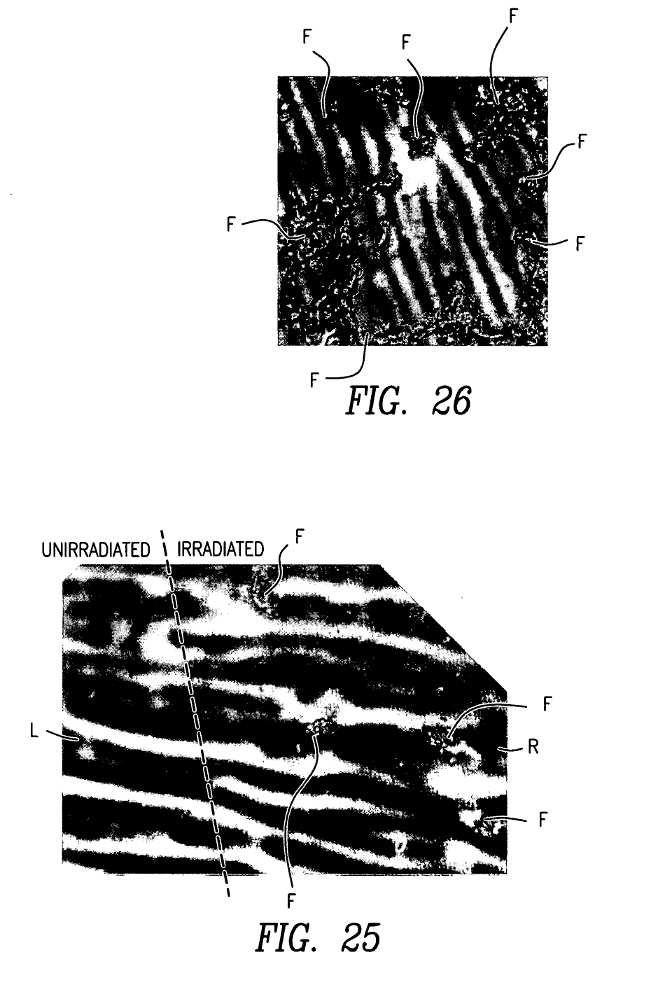

It has been observed that fibroblasts adhere well to cast films of poly(DTE carbonate), but that they do not adhere well to poly(DTE-co-8 wt % PEG carbonate). However, the adhesion of cells to poly(DTE-co-8 wt % PEG carbonate) films can be modulated through the use of electron-beam irradiation. FIG. 25 shows an optical micrograph of a poly(DTE-co-8 wt % PEG carbonate) film where the left side L has not been exposed to electron irradiation and the right side R has been. Fibroblasts F do not adhere to the unirradiated portion L but do adhere to the irradiated portion R. FIG. 26 is an optical micrograph of a control specimen showing that fibroblasts F adhere extensively on unirradiated poly(DTE carbonate).

### Example 5

### Control of Cell Adhesion Using Electron-Beam Patterned Poly(HEMA)

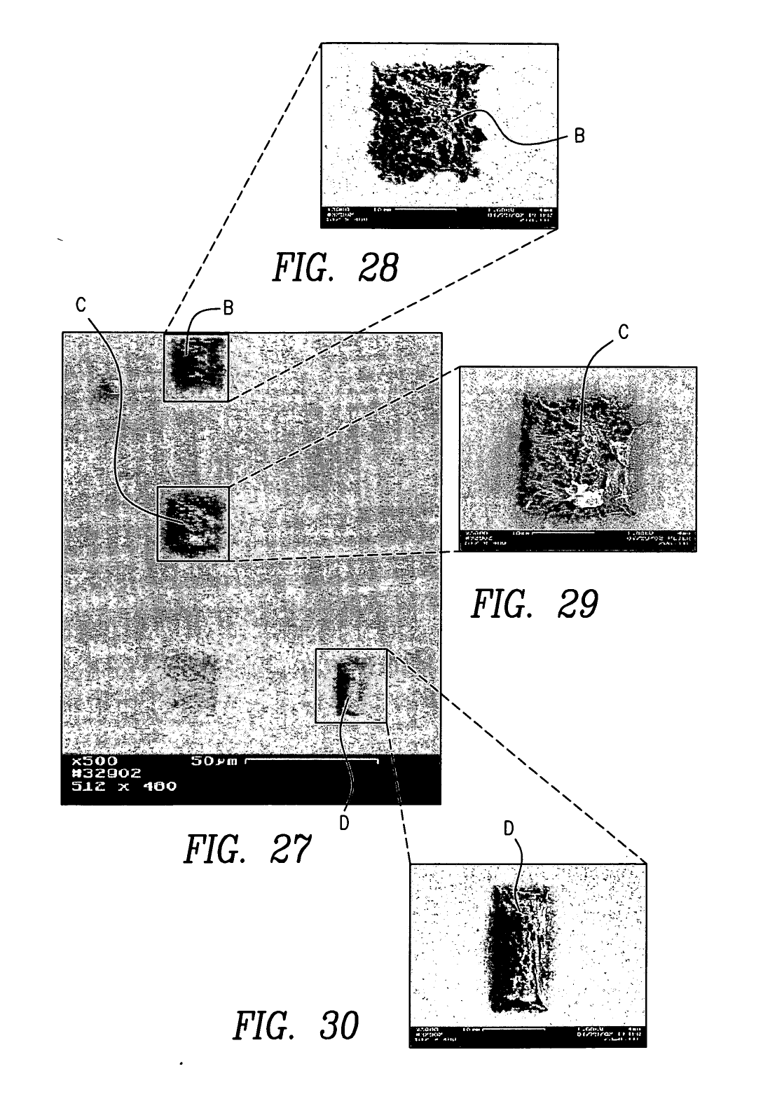

Unlike PEG, PEO, poly(DTE carbonate) and its copolymers, and similar polymers which cross-link in response to radiation, poly(hydroxy ethyl methacrylate) [poly(HEMA)] undergoes chain scission in response to electron beam irradiation in a manner similar to that of poly(methyl methacrylate) [PMMA] and many other acrylate-based polymers. Poly(HEMA) is particularly relevant to biological applications, however. It is generally recognized as being resistant to the adhesion of many cells and is often used in cell culture processes to block cell adhesion and growth. Poly(HEMA), while being fully soluble in various alcohols, swells in water but does not dissolve. Poly(HEMA) films were prepared by solvent casting from a dilute solution of poly(HEMA) in methanol. The films were subsequently treated by electron-beam patterning, protein adsorption, and fibroblast culture procedures similar to those used to study PEG 6800 films in Examples 1-3. FIGS. 27-30 show that electron-beam patterning of poly(HEMA) on silicon can be used to control the size, shape, and relative positions of fibroblasts on the polymer film. FIG. 27 is an optical micrograph of a poly(HEMA) film in which areas B, C and D have been treated by electron-beam patterning at incident doses of 0.1 C/m², 0.3 C/m², and 0.25 C/m², respectively. FIGS. 28, 29 and 30, respectively, are enlargements of the fibroblasts that adhere to areas B, C and D. Examination of FIGS. 27-30 shows that the fibroblasts have been constrained to adopt the specific sizes, shapes and locations of the three areas subjected to electron-beam patterning.

### Example 6

### Formation of Arbitrary Patterns at Micron and Submicron Scales

FIG. 31 shows an optical micrograph of a film of poly(DTE carbonate) on a silicon substrate (side H) that has been electron-beam patterned using a schematic image of a neuron (side G) using the focused electron-beam method of the present invention. The schematic image of the neuron has successfully been reproduced at the length scale of the cell itself. Thus, the method of the present invention provides the ability to create such finely scaled patterns, at micron and sub-micron scales, together with the ability to control the amount of protein locally adsorbed onto the patterned polymer as demonstrated in Examples 2 and 4.

### Example 7

### Patterned Crosslinking of PEO 200k by Wide-Area Irradiation with a Mask

Polymer films on silicon substrates were patterned using wide-area-exposure electron-beam irradiation with a mask. A thin film of PEO 200k was created on a silicon substrate by the methods described in Example 1. In addition, several 3 mm diameter copper grids, of a type that is commercially available for standard use in the field of transmission electron microscopy, were mounted onto the film surface using very small drops of silver conducting paint at the edge of each copper grid. These grids serve as masks and either partially or entirely block incident electrons from reaching the polymer film below. The methodology used is similar to that used in contract printing practiced in a variety of light-based lithographies. Copper grids having other configurations (i.e., 1 mm×2 mm slotted grids, 50 mesh, 100 mesh, 200 mesh, and 400 mesh copper grids) were also successfully used as masks. Masks with custom patterns could be created using established fabrication methods.

A sample of the PEO 200k film was placed on the viewing screen of a Philips CM30 transmission electron microscope (TEM). When vacuum conditions of approximately 10⁻⁶ Torr were achieved, the specimen was exposed to a beam of 100 keV electrons approximately 2.5 cm in diameter. Data from the focused electron-beam patterning experiments (see FIG. 11), together with data available in the literature on the energy-dependence of inelastic electron scattering, were used to guide the choice of electron dose to achieve crosslinking. Films were exposed to doses of 0.05 C/m², 0.21 C/m², and 0.53 C/m² using an incident beam current of approximately 90 nA. After irradiation, the specimen was removed from the vacuum, and the exposed polymer film was developed by immersing the entire sample in sonicated THF at room temperature for 4-5 minutes, rinsing in clean THF, then in Type I water, and finally dried under nitrogen gas. During the sonication procedure, the silver paint was dissolved and the copper grids were also washed from the sample surface.

In all cases, the pattern imposed by the metal masks were transferred to the PEO200k thin film. The regions not protected by the metal mask were crosslinked and not washed away by the developing process. Those protected by the metal mask were either less crosslinked or not crosslinked at all and were removed during the developing procedure. This process of wide-area electron-beam contact printing was successfully used to create arrays consisting of hundreds of square cross-linked PEO 200k pads where the edges of each square pad are approximately 0.025 mm.

### Example 8

### pH-Responsive Microhydrogels from Poly(Electrolyte) Multilayers

Electron-beam patterning was used to create pH-responsive microhydrogels from multilayer films made from PEO and PMAA. The multilayer films were prepared by alternately dipping a silicon wafer into solutions of one or the other component according to the procedure described herein. Buffers of pH 2 and pH 9 were prepared by adding NaH₂PO₄ and Na₂B₄O₇ respectively to Type I water. The following solutions were used in forming the multilayer film: 0.01% quaternized polyvinylpyridine [QPVP] in pH 9 buffer, 1% PEO in pH 2 buffer and 1% PMAA in both pH 2 and pH 9 buffers.

Silicon wafers were cleaned as described in Example 1 and immersed in the QPVP solution for 20 minutes at room temperature, followed by two 1 minute rinses in clean pH 9 buffer. The first layer of PMM was created by immersing the wafer in the PMAA solution for 20 minutes, followed by two 1 minute rinses in pH 9 buffer. Then the pH of the film was changed by dipping the wafer in pH 2 buffer for 5 minutes. A PEO/PMM polyelectrolyte multilayer film consisting of ten layers was then prepared by alternately dipping in PEO and PMAA solutions at pH 2 for 40 minutes each at room temperature. The wafer was rinsed in pH 2 buffer for 1 minute after each step and finally dried.

The irradiation of the multilayer films followed the procedure outlined by Example 1 using a focused electron beam. The beam energy employed was 500 eV. Incident doses from 0.0007 to 1000 C/m² were used. After irradiation, the specimens were immersed and gently agitated for 15 minutes in 200 ml of Type I water at pH=8.

The specimens were studied using liquid cell AFM operated in contact mode. Using the minimum force possible, the samples were scanned in water while changing the environmental pH from 2 to 8.5 and back to 2. The minimum dose necessary to form stable crosslinked pattern was found to be 0.4 C/m². The pad irradiated to a dose of 4 C/m² was studied in detail. The dry film was about 25 m thick. After being immersed in pH=2 water, it swelled to 30 nm. When the pH was then changed to 8.5, the film height increased to 95 nm. Finally, when the pH was changed back to 2, the patch height decreased to 32 nm. These same trends were observed to varying degrees in the other pads irradiated at other doses.

The present invention is directed to the creation of surface-patterned microgels, in particular those of PEG and PEO, though not limited thereto, for controlled adsorption of proteins and adhesion of cells. The microgels are produced by treating polymer films like electron-beam photoresists, but without destroying or removing the microgels from their substrate. Focused electron beams are used to create patterned microgels on surfaces where the enhanced spatial resolution can be exploited to create patterns with characteristic length scales relevant to cellular and sub-cellular processes. Varying the intensity of the radiation exposure allows control of the concentration of proteins that adhere to the resulting microgel. The process can also be used to precisely locate the adhesive junction between cells and a substrate and to confine cell growth within defined areas of the substrate.

The novelty and unobviousness of the invention derive from several factors including, but not limited to, the combination of microgel properties. The microgels are formed from thin films of solid uncross-linked polymers subjected to electron irradiation under vacuum. The use of a focused electron beam allows lateral control of the irradiation to create arbitrary and irregular patterns of microgel on a substrate surface at length scales in the micron and submicron ranges. The swelling properties of the microgels, and, consequently, their adsorptive and absorptive properties, can be controlled by the radiative dose. For certain polymers, the microgel swelling responds to pH and other environmental stimuli.

The patterned microgels also show an unexpected affinity for the adsorption of proteins such as fibronectin. Surprisingly, the amount of protein which adsorbs onto the microgels can be simply controlled by incident dosage of radiation applied to the polymer film during formation of the microgel. Briefly stated, a high resistance to fibronectin adsorption occurs when the gels are lightly cross-linked and swell extensively. At the other extreme, fibronectin adsorption on highly cross-linked gels which swell very little is significantly higher than the level of non-specific adsorption on the bare substrate surface. In between these extremes, the affinity of the microgel for adsorbed fibronectin can be continuously controlled by controlling the radiation exposure, thereby creating, in effect, a grey-scale of adsorptive affinities for protein.

In another unexpected aspect of the invention, the electron-beam patterning process can be used to control cell adhesion to a polymeric substrate by controlling the lateral distribution of the incident radiation doses applied to the polymer substrate. Since it is possible, using the method of the present invention, to create laterally modulated exposures with submicron spatial resolution, the size, shape and position of individual cells on such substrates can be precisely controlled.

Although the invention disclosed herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the invention as defined by the appended claims.

The examples and variants discussed herein disclose the use of electron-beam patterning of the polymers PEG, PEO, PMM, poly(HEMA), poly(DTE carbonate) and poly(DTE-co-PEG carbonate). Those practitioners having ordinary skill in the relevant arts, particularly in those arts relevant to the use of polymer surfaces for the control of protein and cell adhesion, will recognize that a broad range of polymer systems can be used to create patterned microgels under conditions and using methods described herein. Among these systems are:

(I) Polymers containing hydrogen bond donors and/or hydrogen bond acceptors including: polycarboxylic acids such polyacrylic acid and polymethacrylic acid; polynucleotides such as poly(adenylic acid), poly(uridylic acid), poly(cytidylic acid), and poly(inosinic acid); polymers of vinyl nucleic acids such as poly(vinyladenine); polyamino acids such as polyglutamic acid and poly(ε-N-carbobenzoxy-L-lysine); polyalcohols such as poly(vinyl alcohol); polyethers such as poly(ethylene oxide), poly(1,2-dimethoxyethylene), and poly(vinylmethyl ether); polyketones and polyaldehydes such as polyvinylbutyral and poly(N-vinyl-2-pyrrolidone); polyacrylamides such as polyacrylamide, polymethacrylamide and poly(N-isopropylacrylamide); polyamines such as poly(4-amine)styrene; polyesters such poly(cylohexane-1,4-dimethylene terephthalate) and polyhydroxy methyl acrylate; polyphosphazenes such as poly(bis (methylamino) phosphazene) and poly(bis (methoxyethoxyethoxy) phosphazene; polysaccharides such as carboxymethyl cellulose; and copolymers thereof.

(II) Polymers containing charge-forming groups and/or permanently charged groups including: (a) polyacids with charge-forming groups, for example, polycarboxylic acid such as polyacrylic acid, polymethacrylic acid, polyitaconic and polycrotonic acid, polynucleotides such as poly(adenylic acid), poly(cytidylic acid), poly(uridylic acid) and poly(inosinic acid), polymers of vinyl nucleic acids such as poly(vinyladenine), and polyamino acids such as polyglutamic acid; or polyacids containing permanently charged groups such as poly(styrene sulfonic acid), poly(vinyl sulfonic acid) and poly(vinyl phosphoric acid); (b) polybases with permananetly charged and/or chargeable groups for example quaternized poly(vinyl pyridines), quaternized poly(imidazoles), poly(dimethyldiallyl) salts, quaternized poly(diaminoethoxy methacrylates) and poly(diaminoethoxy acrylates) and polyamines such as poly(4-amino)styrene, polyethylene imines, poly(allyl amine) and poly(vinyl amine).

The ordinarily-skilled practitioner will also recognize that patterns may be formed on polymer films by methods other than the use of a focused electron beam or wide-area electron beam on a homogenous, extensive polymer film. For example, a patterned polymer film may be formed before the cross-linking of the polymer is initiated. Films of uncross-linked polymer may be patterned directly onto a surface at micron or submicron dimensions using, for example, stamping, printing, writing, or confinement techniques. The entire surface of the patterned area would then be exposed to radiation to effect the cross-linking of the polymer.

It should also be noted that, although the Examples disclosed herein address the adsorption of fibronectin, the skilled practitioner will recognize that the present invention may be extended to other proteins. Moreover, the skilled practitioner will be able to adapt the present invention to control the adhesion of cells other than fibroblasts, particularly those cell lines, such as endothelial cells or neuronal cells, which tend to adhere to and spread on both natural and synthetic surfaces. It is also worth noting that the ability to form finely scaled, arbitrary patterns, together with the ability to control the amount of protein locally adsorbed onto the patterned polymer suggest radically new applications in the area of directed cell growth such as that associated with axonal regeneration and synapse formation in the central and peripheral nervous systems.

1. A patterned polymer microgel, comprising a polymer film and a substrate on which said polymer film is supported, said polymer film including a superficial pattern having details in the submicron range and a non-patterned portion outside of said superficial pattern, said superficial pattern being distinguished from said non-patterned portion by a distinguishing property.

2. The patterned polymer microgel of claim 1, wherein said substrate has an exposed area which does not support the polymer film, said superficial pattern being distinguished from said exposed area by said distinguishing property.

3. The patterned polymer microgel of claim 1, wherein said superficial pattern is irregularly arranged.

4. The patterned polymer microgel of claim 1, wherein said distinguishing property has an arbitrary distribution within said superficial pattern.

5. The patterned polymer microgel of claim 1, wherein said polymer is a homopolymer.

6. The patterned polymer microgel of claim 1, wherein said polymer is a copolymer.

7. The patterned polymer microgel of claim 1, wherein said polymer film is a multilayer film comprising layers of at least a first polymer and a second polymer, said layers adhering to each other by a bonding mechanism selected from the group consisting of hydrogen bonding, electrostatic bonding and a combination of hydrogen bonding and electrostatic bonding.

8. The patterned polymer microgel of claim 1, said distinguishing property being the degree of cross-linking of said polymer.

9. The patterned polymer microgel of claim 1, said distinguishing property being the degree of swelling of said polymer when said polymer film is exposed to a solvent.

10. The patterned polymer microgel of claim 1, said distinguishing property being the affinity of said polymer for adsorption of a protein.

11. The patterned polymer microgel of claim 10, further comprising a protein adsorbed to said film within said superficial pattern.

12. The patterned polymer microgel of claim 1, said distinguishing property being the affinity of said polymer for adhesion of a cell.

13. The patterned polymer microgel of claim 12, further comprising a cell adhered to said film within said superficial pattern.

14. The patterned polymer microgel of claim 1, further comprising a bioactive molecule reversibly bonded to said layer within said superficial pattern.

15. The patterned polymer microgel of claim 1, wherein said superficial pattern comprises a pH-sensitive microgel.

16. The patterned polymer microgel of claim 1, further comprising an inorganic substrate, said layer being chemically bonded to said inorganic substrate.

17. A method of making a patterned polymer microgel, comprising the steps of:
forming a dry polymer film on a substrate; and
exposing a portion of the dry polymer film to a source of electron radiation under high vacuum so as to form a pattern of exposed polymer film within the portion of the dry polymer film.

18. The method of claim 17, further comprising the step of removing a portion of the dry polymer film from the substrate so as to leave the pattern of exposed polymer film on the substrate.

19. The method of claim 17, wherein the source of electron radiation is a focused electron beam and the step of exposing a portion of the dry polymer film to the source of radiation energy includes the step of rastering the focused electron beam across a series of positions over the portion of dry polymer film.

20. The method of claim 19, wherein the step of exposing a portion of the dry polymer film to the source of electron radiation includes the step of modulating the intensity of the exposure of the portion of dry polymer film at each of the positions so that the intensity of the exposure within the pattern varies along a dimension parallel to a surface of the dry polymer film.

21. The method of claim 19, wherein the dry polymer film is exposed to radiation energies in a range of from about 500 eV to about 300 keV and the focused electron beam has a characteristic diameter of from about 1 nanometer to about 1 micron.

22. The method of claim 19, wherein the dry polymer film is exposed to radiation energies in a range of from about 500 eV to about 20 keV and the focused electron beam has a characteristic diameter of from about 1 nanometer to about 1 micron.

23. The method of claim 17, wherein the step of exposing a portion of the dry polymer film to a source of electron radiation includes the steps of forming a patterned radiation mask and then placing the patterned radiation mask between the portion of the dry polymer film and the source of electron radiation so that areas of the film outside of the pattern are exposed to substantially less radiation energy than are the areas of the film within the pattern.

24. The method of claim 23, wherein the portion of the dry polymer film is exposed to radiation energies in a range of from about 500 eV to about 300 keV

25. The method of claim 23, wherein the portion of the dry polymer film is exposed to radiation energies in a range of from about 10 keV to about 300 keV.

26. The method of claim 17, wherein the high vacuum is on the order of 10⁻⁶ Torr.

27. The method of claim 18, wherein the substrate is an inorganic substrate.

28. A method of controlling protein adsorption on a polymer film, comprising the steps of:
forming a dry polymer film on a substrate, said polymer film being resistant to the adsorption of proteins;
exposing a portion of the dry polymer film to a source of electron radiation under high vacuum so as to form a pattern of highly cross-linked polymer film within the portion of dry polymer film; and
contacting the dry polymer film with a medium containing a protein, whereby the protein adsorbs to the pattern of highly cross-linked polymer film.

29. The method of claim 28, wherein the source of electron radiation is a focused electron beam and the step of exposing a portion of the dry polymer film to the source of electron radiation includes the step of rastering the focused electron beam across a series of positions over the portion of dry polymer film.

30. The method of claim 29, wherein the step of exposing a portion of the dry polymer film to the source of electron radiation includes the step of modulating the intensity of the exposure of the portion of dry polymer film at each of the positions so that the intensity of the exposure within the pattern varies along a dimension parallel to a surface of the dry polymer film.

31. The method of claim 28, wherein the step of exposing a portion of the dry polymer film to a source of electron radiation includes the steps of forming a patterned radiation mask that passes radiation through the pattern and then placing the patterned radiation mask between the portion of the dry polymer film and the source of radiation energy so that areas of the film outside of the pattern are exposed to substantially less radiation energy than are the areas of the film within the pattern.

32. A method of controlling cell adhesion on a polymer film, comprising the steps of:
forming a dry polymer film on a substrate, said polymer film being resistant to cell adhesion;
exposing a portion of the dry polymer film to a source of electron radiation under high vacuum so as to form a pattern of highly cross-linked polymer film within the portion of dry polymer film; and
contacting the dry polymer film with a medium having cells therein, whereby a cell adheres to the highly cross-linked polymer film within the pattern.

33. The method of claim 32, wherein the source of electron radiation is a focused electron beam and the step of exposing a portion of the dry polymer film to the source of electron radiation includes the step of rastering the focused electron beam across a series of positions over the portion of dry polymer film.

34. The method of claim 33, wherein the step of exposing a portion of the dry polymer film to the source of electron radiation includes the step of modulating the intensity of the exposure of the portion of dry polymer film at each of the positions so that the intensity of the exposure within the pattern varies along a dimension parallel to a surface of the dry polymer film.

35. The method of claim 32, wherein the step of exposing a portion of the dry polymer film to a source of electron radiation includes the steps of forming a patterned radiation mask that passes radiation through the pattern and then placing the patterned radiation mask between the portion of the dry polymer film and the source of radiation energy so that areas of the film outside of the pattern are exposed to substantially less radiation energy than are the areas of the film within the pattern.
